(19) United States
(12) Patent Application Publication
(10) Pub. No.: US 2010/0186360 A1
(43) Pub. Date: Jul. 29, 2010

(54) ARRANGEMENT FOR ADJUSTING THE POSITION OF CUTTING MEANS IN A CUTTING DEVICE

(75) Inventor: Mauno Keski-Luopa, Lahti (FI)

Correspondence Address: YOUNG & THOMPSON, 209 Madison Street, Suite 500, Alexandria, VA, 22314, US

(73) Assignee: ACTIONECO OY, Lahti (FI)

(21) Appl. No.: 12/667,545

(22) PCT Filed: Jul. 4, 2008
(86) PCT No.: PCT/FI2008/050415

§ 371 Date: Mar. 24, 2010

(30) Foreign Application Priority Data
Jul. 6, 2007 (FI) 20070537

(51) Int. Cl. A01D 34/835

(52) U.S. Cl. 56/10.2 E

(57) ABSTRACT

An arrangement for adjusting the position of the cutting elements (7) of a cutting device (1) meant for cutting vegetation. The cutting elements include a cutting unit (9) and a lifting and lowering device (4; 4a). The arrangement includes measuring elements (10; 10a, 10b) and an adjusting unit (5a). An advantageous motional range (L) for the cutting unit is defined in the arrangement. The measuring elements are arranged to detect the position of the cutting unit in relation to the advantageous motional range and to transmit the position data to the adjusting unit arranged to receive the position data and control the lifting and lowering device on the basis thereof. The lifting and lowering device is arranged to adjust the position of the cutting unit on the basis of instructions received in the position adjusting unit in order to maintain the position of the cutting unit within an advantageous motional range.

The invention relates to the arrangement defined in the preamble of the independent claim 1 for adjusting the position of cutting means in a cutting device meant for cutting vegetation.

The invention also relates to a cutting unit according to the independent claim 10 for cutting vegetation, particularly lawn.

In a riding lawn mower according to the known US patent publication U.S. Pat. No. 6,082,086, the three cutting units provided at the front part thereof, of which the first cutting unit is arranged in the first row and two other cutting units are arranged in a second row behind the first cutting unit, adjacently and partly in an overlapping manner with respect to the first cutting unit. The cutting units swing independently, supported by their own axis, when conforming to an ascending or descending terrain. In addition, the driver can lift the cutting units by lifting and lowering means that are provided with cylinders.

The drawback with prior art applications has been the effect that the changes of the terrain have on the cutting result. When the terrain descends in front of a mower that is driven forward, the cutting means do not closely conform to the terrain, but the cutting means may rise, particularly at the front, higher than the determined cutting height. Respectively, as the terrain rises in front of the mower, the cutting means, and particularly the front part thereof, are pressed down, and as a result, the cutting means may even plough the ground. As a consequence, in a rolling terrain the cutting result of a lawn or corresponding vegetation is not homogeneous, but the length of the cut vegetation varies. This affects for instance the appearance of a golf course, and particularly its quality. It is extremely difficult to plan ahead a putt on a green where the length of the lawn varies.

Moreover, a drawback in prior art cutting devices is that in an uneven terrain, the attention of the driver is divided between driving the cutting device and adjusting the height of the cutting means, in which case the proceeding speed of the cutting device may be slowed during the height adjustments. The fact that the driver must divide his attention to various tasks also has its effects on the driving safety of the cutting device.

The object of the present invention is to eliminate the above mentioned drawbacks.

Another object of the invention is to realize a new arrangement for adjusting the cutting means of a cutting device meant for cutting vegetation.

Yet another object of the invention is to realize a new cutting device for cutting vegetation, particularly lawn.

An advantage of the invention, in comparison with the prior art, is that the achieved cutting result even in an uneven terrain is homogeneous, which has its effects for instance on the playing conditions and appearance of a golf course.

Another advantage of the invention, in comparison with the prior art, is that the adjusting of the cutting means height is carried out automatically, so that the driver can concentrate on driving the vehicle, instead of adjusting the cutting means.

The arrangement according to the invention is characterized by what is set forth in the independent claim 1. The dependent claims 2-9 is represent other preferred embodiments of the invention.

The cutting device according to the invention is characterized by what is set forth in the independent claim 10.

Various embodiments of the invention can be combined when applicable.

The invention is explained in more detail below, with reference to the appended drawings, where

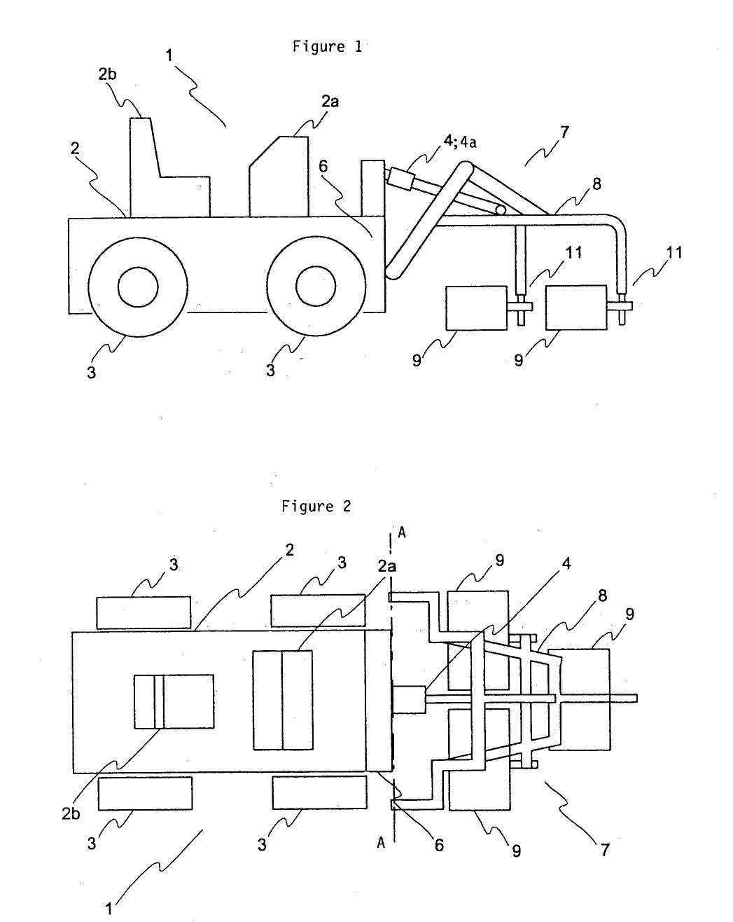

FIG. 1 is a schematical side-view illustration of a cutting device, where the arrangement according to the invention is applied;

FIG. 2 shows the cutting device of FIG. 1, seen from above;

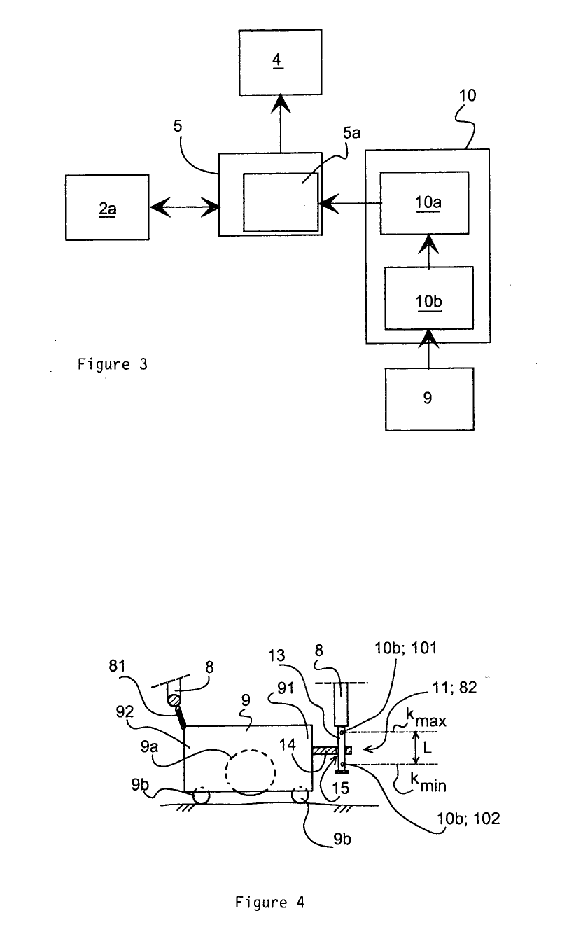

FIG. 3 illustrates an arrangement according to the invention, seen in a simplified block diagram;

FIG. 4 is a side-view illustration of a few cutting means, particularly the cutting unit of a cutting device, which cutting unit is provided with a movement detection element and measuring sensors; and

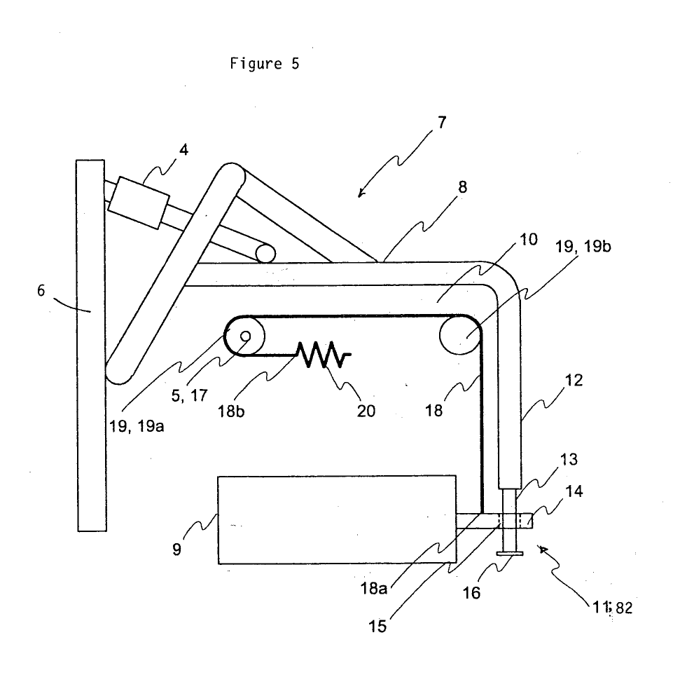

FIG. 5 is a side-view illustration of a few other cutting means, particularly the cutting unit of a cutting device, which cutting unit is provided with a movement detection element and measuring sensors.

Like reference numbers for like parts are used in the drawings.

FIGS. 1 and 2 are schematical illustrations, with a view from the side and from the top, of a cutting device 1 that is particularly suited for cutting vegetation, particularly lawn, grass, meadows or the like. The cutting device 1 comprises a frame 2 and, in connection with the frame 2, the cutting means 7 proper. The driver drives and uses the cutting device 1 by means of the management and control means 2a. The cutting device 1 is provided with a motor, preferably with electric motors, by means of which it is moved supported by wheels 3 or the like, fitted in connection with the frame, and the driver's seat 2a is in this example arranged on top of the frame 2. Neither the driver's seat 2b nor the management and control means 2a are described in more detail in the specification or the Figures.

In addition, the cutting device 1 comprises a lifting and lowering device 4 that is fitted in between the frame 2 and the cutting means 7. The lifting and lowering device 4 is used for moving the cutting means 7 in a hinge-like fashion with respect to the turning axis A-A and the frame 2, at least by lowering the cutting means 7 down to the working position, and respectively by lifting them up to the rest position (transport position). The lifting and lowering device 4 is realized for example by means of a hydraulic cylinder or a corresponding compression cylinder, but preferably it is realized by means of a spindle motor 4a. The spindle motor 4a comprises an electric motor, preferably a servomotor, by which a linear motion can be realized. The lifting and lowering device 4; 4a is controlled by the management and control means 2a provided in connection with the frame 2 of the cutting device, operated by the driver and/or by intermediation of the control unit 5. The lifting and lowering device 4 is advantageously fitted at the front end 6 of the frame 2, where also the cutting means 7 are arranged.

The cutting means 7 comprise a cutting means frame 8 and one or several cutting units 9 arranged in connection with said frame. The cutting unit 9 is fastened by suitable elastic fastening elements 81, 82 that conform to the motion of the cutting device, preferably at the front and rear parts 91, 92 when viewed in the motional direction, to the cutting means frame 8. The cutting means frame 8 and the cutting unit 9 attached to it can be lifted and lowered by the lifting and lowering device 4; 4a. The cutting unit 9 comprises a cutter, such as cutting reel 9a for cutting lawn or corresponding vegetation, and support elements, for example support reels or wheels 9b, for supporting the cutting unit 9 against the ground, particularly when cutting lawn or corresponding vegetation.

The cutting device 1 illustrated in FIGS. 1 and 2 includes three cutting units 9 that are arranged preferably partly adjacently, but also partly in an overlapping fashion and in succession. However, the number of the cutting units 9 can vary in different cutting devices 1. The cutting units 9 are arranged, depending on the size of the cutting device 1 and on the number of cutting units 9, so that a stretch of lawn or corresponding vegetation that is as wide as possibly can be cut in an even and homogeneous manner when the cutting device 1 is moved forward.

FIG. 3 is a simplified block diagram illustrating an arrangement according to the invention for detecting the position of the cutting unit 9. FIGS. 4 and 5 illustrate a few advantageous measuring elements of the arrangement. For the sake of clarity, only one cutting unit 9 is illustrated in connection with the cutting means frame 8.

The arrangement according to the invention for adjusting the position of the cutting means 7 of a cutting device 1 comprises measuring elements 10 and an adjusting unit 5a, as is illustrated for example in FIG. 3. The measuring elements 10 are arranged to detect the position of one or several cutting units 9, particularly the height position thereof, in relation to an advantageous and predetermined motional range L (cf. FIG. 4), and to transmit the position data to the adjusting unit 5a. Here the notion ‘position data’ refers to at least the maximum value kₘₐₓ and minimum value kₘᵢₙ of the motional range L, i.e. the data of surpassing and/or falling short of the motional range. The adjusting unit 5a is in turn arranged to receive position data from the measuring elements 10. The lifting and lowering device 4; 4a is controlled by means of the adjusting unit 5a, by utilizing the position data, so that the cutting unit 7 is maintained within a predetermined motional range L. This motional range defines an essentially vertical fluctuation range, within the limits of which the cutting unit 9 must keep in relation to the cutting means frame 8 and to the cutting device 1, in order to ensure that lawn, grass or other corresponding vegetation is cut essentially at the desired height.

The adjusting unit 5a preferably forms part of a control unit 5, which is preferably realized as a suitable digital data processing unit, such as a microprocessor, and the auxiliary devices thereof. Consequently, the functions of the adjusting unit 5a are realized as program-controlled groups of operations.

The measuring elements 10 comprise one or several measuring sensors 10b and a measuring unit 10a, to which the sensor/sensors 10a are connected. In addition, the measuring elements comprise a movement detection element 11, which is arranged in connection with the cutting unit 9 and the cutting means frame 8. The measuring sensor/-sensors 10a are arranged in connection with the movement detection element 11. The movement detection element 11 is used for detecting how the cutting unit 9 follows the configuration of the ground in relation to the cutting device 1, particularly to the cutting means frame 8, when the cutting device 1 is used for cutting grass, lawn or corresponding vegetation.

In a preferred embodiment, the movement detection element 11 comprises a pin element 13 that is fastened to the cutting means frame 8, and a bracket 14 that is fastened to the cutting unit 9. The bracket 14 and the pin element 13 are elements that move in relation to each other, and the position of the cutting unit 9 is observed from their relative position.

The movement detection element 11 comprises a bracket 14 that is fastened to the cutting unit 9, preferably to its front part 91. The bracket 14 is provided with an aperture 15 or a corresponding gap that is arranged to proceed essentially vertically through the bracket 14. In addition, the detector element comprises a pin element 13 that is fastened to the cutting means frame 8 and arranged to be vertically matched with the bracket 14 of the cutting unit 9 and particularly with the aperture 15 thereof. The pin element 13 is arranged to proceed through the aperture or the like 15 of the bracket 14, so that the pin element 13 is free to move unhindered in the aperture 15. The lower end of the pin element 13 is preferably provided with an expansion 16; 16a or a corresponding stopping element, the maximum diameter of which is larger than the diameter of the aperture 15 of the bracket 14. Thus the bracket 14 is prevented from being detached from the pin element 13, particularly when the cutting unit 9 is being used. This is also important when the detector element 11 is arranged to serve as a fastening element 81 of the cutting unit 9.

As the cutting device 1 is moved and used for cutting lawn or other corresponding vegetation, the cutting means 7 are lowered down in the working, i.e. cutting position by means of the lifting and lowering device 4, 4a. Now the cutting unit 9 follows the configuration of the ground surface, and at the same time the bracket 14 of the cutting unit 9, particularly by intermediation of the aperture 15 thereof, is free to move in the pin element 13, preferably within the predetermined motional range L. The lower edge of said motional range L, i.e. its minimum value, defines the first expansion 16; 16a arranged at the lower end of the pin element 13. In a corresponding way, there can also be defined the top edge of the motional range L, i.e. its maximum value, by arranging the second expansion 16b or a corresponding marking element in the pin element 13, at the motional range distance from the first expansion 16a.

The cutting unit 9 supported against the ground by support reels or the like 9b conforms to the configuration of the ground surface more flexibly and accurately than the relatively large cutting unit 1 moved on wheels 3 and the cutting means frame 8 attached thereto, in which case the cutting unit 9 in its flexible fastening arrangement is free to move, in relation to the cutting device and the cutting means frame 8, particularly in the allowed motional range L.

It is pointed out that the motional range L can be defined independently of the expansions 16a, 16b or the like, for instance by installing the measuring sensor/sensors 10b suitably in connection with the movement detection element 11. The measuring sensor 10b is arranged in connection with the bracket 14 of the cutting unit 9 and/or the pin element 13 of the cutting means frame 8, so that the position of the cutting unit 9, particularly its height position, with respect to the motional range L and particularly its maximum and minimum values kₘₐₓ, kₘᵢₙ can be reliably detected.

In a preferred embodiment of the invention, the measuring sensors 10b; 101, 102 are arranged in connection with the pin element 13. The measuring sensors 101, 102 are preferably arranged inside the pin element 13, as is illustrated in FIG. 4. The sensors 101, 102 are preferably detectors that can be used for detecting the vicinity of the bracket 14. In that case the measuring sensors 10b; 101, 102 are fitted at the extreme points of the allowed motional range L of the pin element 13, i.e. at the maximum and minimum values kₘₐₓ, kₘᵢₙ, in which case the reaching of these threshold values is detected immediately in said sensors. The measuring sensors 101, 102 are for example optical, capacitive or electromagnetic sensors.

In another preferred embodiment of the invention, the measuring sensor 10b; 17 is arranged at a distance from the movement detection element 11, as is illustrated in FIG. 5. The measuring sensor 17 observes the motion of the detector element 11 by means of a transmission element 18, which is advantageously composed of wire, chain, rope or the like, or is a combination of at least two of these. For example, the transmission element 18 can be realized so that those parts of the transmission element 18 that get into contact with the idler wheels 19 are composed of chain, and the rest of the transmission element is made of wire. The transmission element 18 is at the first end 18a fastened to the fastening element 14 attached to the cutting unit 9, and at the other end 18b to the cutting means frame 8 or elsewhere in the cutting means 7 by means of a spring 20 or another elastic element. The fastening of the spring 20 to the cutting means frame 8 is not illustrated in the drawings. The purpose of the spring 20 or the like is to keep the transmission element 18 tight. The transmission element 18 is arranged to proceed in between the first end 18a and the second end 18b, over at least one idler wheel 19. FIG. 5 shows a simplified arrangement realized by means of two idler wheels 19a and 19b. The transmission element 18 is arranged to proceed over at least one idler wheel 19, preferably for at least 180 degrees.

The measuring sensor 17, which is advantageously an absolute sensor measuring the twist, is arranged in connection with the idler wheel 19, over which the transmission element 18 proceeds preferably for at least 180 degrees, in order to detect the motion of the idler wheel 19, which is proportional to the vertical motion of the fastening element 14 of the cutting unit in relation the pin element 13 thereof.

In between the measuring sensor 10b; 101, 102; 17 and the adjusting unit 5a fitted therebetween, there are arranged data transmission means, by means of which measurement data is transmitted from the measuring sensor to the adjusting unit 5a. In between the adjusting unit 5a and the lifting and lowering devices 4; 4a, there are also arranged data transmission means, by means of which the adjusting unit 5 transmits control commands to the lifting and lowering devices 4; 4a for lifting and lowering the cutting means 7 back to the predetermined motional range L.

In addition to data transmission interfaces, the adjusting unit 5a advantageously also comprises one or several microprocessors and a memory, in which there is recorded a predetermined maximum value kₘₐₓ of the motional range of the cutting unit 9, corresponding to the measurement data from the measuring sensor 10b, as well as the minimum value kₘᵢₙ of the motional range L of the cutting unit 9, corresponding to the measurement data from the measuring sensor 10b. When the adjusting unit 5a detects that the measurement result from the measuring sensor 10b shows that the position of the cutting unit 9 has surpassed the preset maximum value, or that the position of the cutting unit 9 has fallen short of the preset minimum value, the adjusting unit 5a guides the lifting and lowering device 4; 4a in order to make the cutting unit 9 again function within the predetermined motional range L.

The adjusting unit 5a is arranged to function so that it starts the control operations of the lifting and lowering devices 4; 4a when the position of the cutting unit 9 surpasses the maximum value of the motional range L, or when the position of the cutting unit 9 falls short of the minimum value of the motional range. On the basis of the controlling operations of the adjusting unit 5a, the lifting and lowering devices 4; 4a shift the cutting unit 9 back to the predetermined motional range L, preferably in the center of said motional range. After this, the adjusting unit 5a ends the controlling operation of the lifting and lowering devices 4; 4a. The purpose of this arrangement is to save the power supply of the cutting device 1, which is preferably a battery.

Let us now explain the operation of the automatic adjusting arrangement of the cutting means 7, particularly with reference to the measuring sensor 10b; 17 arranged according to FIG. 5. Apparently the adjusting arrangement functions in a corresponding way also by means of the measuring sensors 10b; 101, 102 illustrated in FIG. 4.

As the cutting device 1 proceeds along an ascending terrain, the foremost cutting unit 9 moves vertically upwards, and at the same time the bracket 14 of the detector element 11 moves vertically upwards in relation to the pin element 13 of the detector element 11. As the bracket 14 moves vertically upwards, both idler wheels 19a and 19b are turned counterclockwise, for a stretch corresponding to the vertical motion of the bracket 14, while a spring 20 or a corresponding element keeps the transmission element 18 tight. The measuring sensor 17 observes the counterclockwise turning of the idler wheel 19a and at the same time transmits measurement data of the position of the foremost cutting unit 9 to the adjusting unit 5a by means of the data transmission means. From the measurement data, the adjusting unit 5a detects when the position of the foremost cutting unit 9 surpasses the predetermined maximum value kₘₐₓ of the motional range L, and sends, by intermediation of the data transmission means, a control command to the lifting and lowering devices 4 to raise the height of the cutting means 7, so that the foremost cutting unit 9 again moves within the predetermined motional range L defined by the maximum value kₘₐₓ and the minimum value kₘᵢₙ.

Respectively, when the cutting device 1 proceeds in a descending terrain, the foremost cutting unit 9 moves vertically downwards, and at the same time the bracket 14 of the detector element 11 moves vertically downwards in relation to the pin element 13 of the detector element 11. As the bracket 14 moves vertically downwards, both idler wheels 19a and 19b are turned clockwise, for a stretch corresponding to the vertical motion of the bracket 14, while the spring 20 or a corresponding element keeps the transmission element 18 tight. The measuring sensor 17 observes the clockwise turning of the idler wheel 19a and at the same time transmits measurement data of the position of the foremost cutting unit 9 to the adjusting unit 5a by means of the data transmission means. From the measurement data, the adjusting unit 5a detects when the position of the foremost cutting unit 9 falls under the predetermined minimum value kₘᵢₙ of the motional range L, and sends, by intermediation of the data transmission means, a control command to the lifting and lowering devices 4 to lower the height of the cutting means 7, so that the foremost cutting unit 9 again moves within the predetermined motional range L defined by the maximum and minimum values.

The invention is not restricted to the above described embodiment only, but many modifications are possible within the scope of the inventive idea defined in the claims.

1. An arrangement for adjusting the position of the cutting means (7) of a cutting device (1) meant for cutting vegetation, said cutting means (7) comprising a cutting unit (9) and lifting and lowering devices (4), characterized in that the arrangement comprises measuring elements (10; 10a, 10b) and an adjusting unit (5a), in which arrangement
there is defined an advantageous motional range (L) for the cutting unit (9),
the measuring elements (10; 10a, 10b, 11) are arranged to detect the position of the cutting unit (9) with respect to an advantageous motional range (L) and to send the position data to the adjusting unit (5a),
the adjusting unit (5a) is arranged to receive the position data and to control the lifting and lowering device (4) on the basis thereof, and
the lifting and lowering devices (4) are arranged to adjust the position of the cutting unit (9) on the basis of the instructions received in the adjusting unit (5a) in order to maintain the position of the cutting unit (9) within an advantageous motional range (L).

2. An arrangement according to claim 1, characterized in that the measuring elements (10) comprise a movement detection element (11) and at least one measuring sensor (10b), the detector element (11) of which is arranged in connection with the cutting unit (9), said detector element (11) being used for detecting how the cutting unit (9) conforms to the shapes of the ground in relation to the cutting device (1), when the cutting device is used for cutting lawn, grass or corresponding vegetation, said measuring sensor (10b) being fitted in connection with the detector element (11).

3. An arrangement according to claim 1, characterized in that the detector element (11) comprises a pin element (13) that is fastened to the cutting means frame (8), and a bracket (14) that is fastened to the cutting unit (9), said bracket (14) and pin element (13) being movable with respect to each other.

4. An arrangement according to claim 3, characterized in that the measuring sensors (10b; 101, 102) are fitted in connection with the pin element (13).

5. An arrangement according to claim 3, characterized in that the measuring sensor (10b; 17) is fitted at a distance from the movement detection element (11).

6. An arrangement according to claim 5, characterized in that in connection with the measuring sensor (17), there is arranged at least one idler wheel (19), to proceed over which there is arranged a transmission element (18), such as a wire or the like, said measuring sensor (17) being arranged to observe the movement detection element (11) by intermediation of the transmission element (18).

7. An arrangement according to claim 6, characterized in that the measuring sensor (17) is arranged to measure the twist of the idler wheel (19) provided in connection with the measuring sensor (17).

8. An arrangement according to claim 6, characterized in that the measuring sensor (17) is an absolute sensor.

9. An arrangement according to claim 1, characterized in that the first end (18a) of the transmission element (18) is fitted in connection with the detector element (11), and the second end (18b) is fitted in connection with the cutting means frame (8) by intermediation of a spring (20).

10. A cutting device (1) meant for cutting vegetation, particularly a lawn, comprising cutting means (7) including at least one cutting unit (9) and a lifting and lowering device (4), characterized in that the cutting device (1) comprises the means and arrangement according to claim 1.

11. An arrangement according to claim 2, characterized in that the detector element (11) comprises a pin element (13) that is fastened to the cutting means frame (8), and a bracket (14) that is fastened to the cutting unit (9), said bracket (14) and pin element (13) being movable with respect to each other.

12. An arrangement according to claim 7, characterized in that the measuring sensor (17) is an absolute sensor.
